(19) United States
(12) Patent Application Publication
(10) Pub. No.: US 2013/0162576 A1
(43) Pub. Date: Jun. 27, 2013

(54) USER INTERFACE APPARATUS

(71) Applicant: SANYO Electric Co., Ltd., Moriguchi-shi (JP)

(72) Inventor: Akira TOBA, Osaka-shi (JP)

(73) Assignee: SANYO Electric Co., Ltd., Moriguchi-shi (JP)

(21) Appl. No.: 13/727,301

(22) Filed: Dec. 26, 2012

(30) Foreign Application Priority Data
Dec. 26, 2011 (JP) 2011--283767

(51) Int. Cl. G06F 3/041

(52) U.S. Cl. CPC G06F 3/041
USPC 345/173

(57) ABSTRACT

A user interface apparatus includes a first updater. A first updater updates a display of a monitor screen according to a first rule when a touch operation of a first manner to the monitor screen is detected. A second updater updates the display of the monitor screen according to a second rule when a touch operation of a second manner to the monitor screen is detected. A displayer displays a specific icon on the monitor screen when an updating manner of the display of the monitor screen satisfies an error condition. A specific updater updates the display of the monitor screen according to the first rule when a touch operation to the specific icon displayed by the displayer is detected.

### CROSS REFERENCE OF RELAYED APPLICATION

The disclosure of Japanese Patent Application No. 2011-283767, which was filed on Dec. 26, 2011, is incorporated herein by reference.

### BACKGROUND OF THE INVENTION

1. Field of the Invention

The present invention relates to a user interface apparatus, and in particular, relates to a user interface apparatus which updates a display of a monitor screen in response to a touch operation to the monitor screen.

2. Description of the Related Art

According to one example of this type of apparatus, a touch panel which detects a contact point is arranged above a display surface of a display portion which displays a plurality of icons. Moreover, a plurality of touch effective ranges are respectively set to the plurality of icons. If the detected contact point exists within any one of the touch effective ranges, a process according to a corresponding icon is executed. In contrary, if the detected contact point deviates from any touch effective ranges, a display format of the icon is changed so as to reduce a mistake in selecting the icon. However, in the above-described apparatus, touch operations of a plurality of manners such as a flick operation and a tap operation are not assumed, and therefore, an operability is limited.

### SUMMARY OF THE INVENTION

A user interface apparatus according to the present invention comprises: a first updater which updates a display of a monitor screen according to a first rule when a touch operation of a first manner to the monitor screen is detected; a second updater which updates the display of the monitor screen according to a second rule when a touch operation of a second manner to the monitor screen is detected; a displayer which displays a specific icon on the monitor screen when an updating manner of the display of the monitor screen satisfies an error condition; and a specific updater which updates the display of the monitor screen according to the first rule when a touch operation to the specific icon displayed by the displayer is detected.

According to the present invention, a display control program recorded on a non-transitory recording medium in order to control a user interface apparatus provided with a monitor screen, the program causing a processor of the user interface apparatus to perform the steps comprises: a first updating step of updating a display of a monitor screen according to a first rule when a touch operation of a first manner to the monitor screen is detected; a second updating step of updating the display of the monitor screen according to a second rule when a touch operation of a second manner to the monitor screen is detected; a displaying step of displaying a specific icon on the monitor screen when an updating manner of the display of the monitor screen satisfies an error condition; and a specific updating step of updates the display of the monitor screen according to the first rule when a touch operation to the specific icon displayed by the displaying step is detected.

According to the present invention, a display control method executed by a user interface apparatus provided with a monitor screen, comprises: a first updating step of updating a display of a monitor screen according to a first rule when a touch operation of a first manner to the monitor screen is detected; a second updating step of updating the display of the monitor screen according to a second rule when a touch operation of a second manner to the monitor screen is detected; a displaying step of displaying a specific icon on the monitor screen when an updating manner of the display of the monitor screen satisfies an error condition; and a specific updating step of updates the display of the monitor screen according to the first rule when a touch operation to the specific icon displayed by the displaying step is detected.

The above described features and advantages of the present invention will become more apparent from the following detailed description of the embodiment when taken in conjunction with the accompanying drawings.

### BRIEF DESCRIPTION OF THE DRAWINGS

FIG. 1 is a block diagram showing a basic configuration of one embodiment of the present invention;

FIG. 2 is a block diagram showing a configuration of one embodiment of the present invention;

FIG. 3 is an illustrative view showing one example of an image displayed on an LCD monitor;

FIG. 4 is an illustrative view showing another example of the image displayed on the LCD monitor;

FIG. 5 is an illustrative view showing still another example of the image displayed on the LCD monitor;

FIG. 6 is an illustrative view showing one example of a transition behavior of a photographed image displayed on the LCD monitor;

FIG. 7 is an illustrative view showing one example of a transition behavior of a menu image displayed on the LCD monitor;

FIG. 8 is an illustrative view showing one portion of behavior of the embodiment in FIG. 2;

FIG. 9 is an illustrative view showing another portion of behavior of the embodiment in FIG. 2;

FIG. 10(A) is an illustrative view showing one example of a state where a small size of an alternate icon is overlapped on the photographed image;

FIG. 10(B) is an illustrative view showing one example of a state when a large size of an alternate icon is overlapped on the photographed image;

FIG. 11(A) is an illustrative view showing one example of a state when the small size of the alternate icon is overlapped on the menu image;

FIG. 11(B) is an illustrative view showing one example of a state when the large size of the alternate icon is overlapped on the menu image;

FIG. 12 is a flowchart showing one portion of behavior of a CPU applied to the embodiment in FIG. 2;

FIG. 13 is a flowchart showing another portion of behavior of the CPU applied to the embodiment in FIG. 2;

FIG. 14 is a flowchart showing still another portion of behavior of the CPU applied to the embodiment in FIG. 2;

FIG. 15 is a flowchart showing yet another portion of behavior of the CPU applied to the embodiment in FIG. 2; and

FIG. 16 is a block diagram showing a configuration of another embodiment of the present invention.

### DETAILED DESCRIPTION OF THE PREFERRED EMBODIMENTS

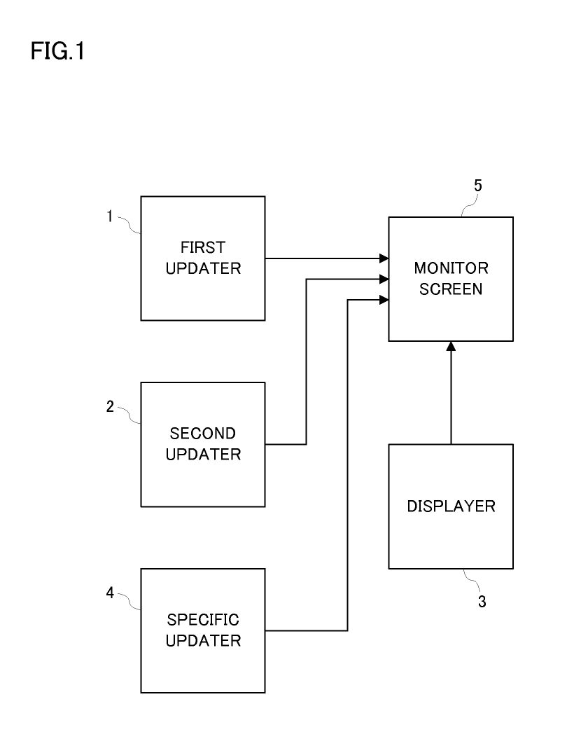

With reference to FIG. 1, a user interface apparatus according to one embodiment of the present invention is basically configured as follows: A first updater 1 updates a display of a monitor screen 5 according to a first rule when a touch operation of a first manner to the monitor screen 5 is detected. A second updater 2 updates the display of the monitor screen 5 according to a second rule when a touch operation of a second manner to the monitor screen 5 is detected. A displayer 3 displays a specific icon on the monitor screen 5 when an updating manner of the display of the monitor screen 5 satisfies an error condition. A specific updater 4 updates the display of the monitor screen 5 according to the first rule when a touch operation to the specific icon displayed by the displayer 3 is detected

When the touch operation of the first manner is erroneously detected as the touch operation of the second manner, the display of the monitor screen 5 is updated according to the second rule. When the error condition is satisfied as a result of frequency of the update according to the second rule, the specific icon is displayed on the monitor screen 5. Updating the display according to the first rule is executed in response to the touch operation to the specific icon. Thereby, an operability is improved

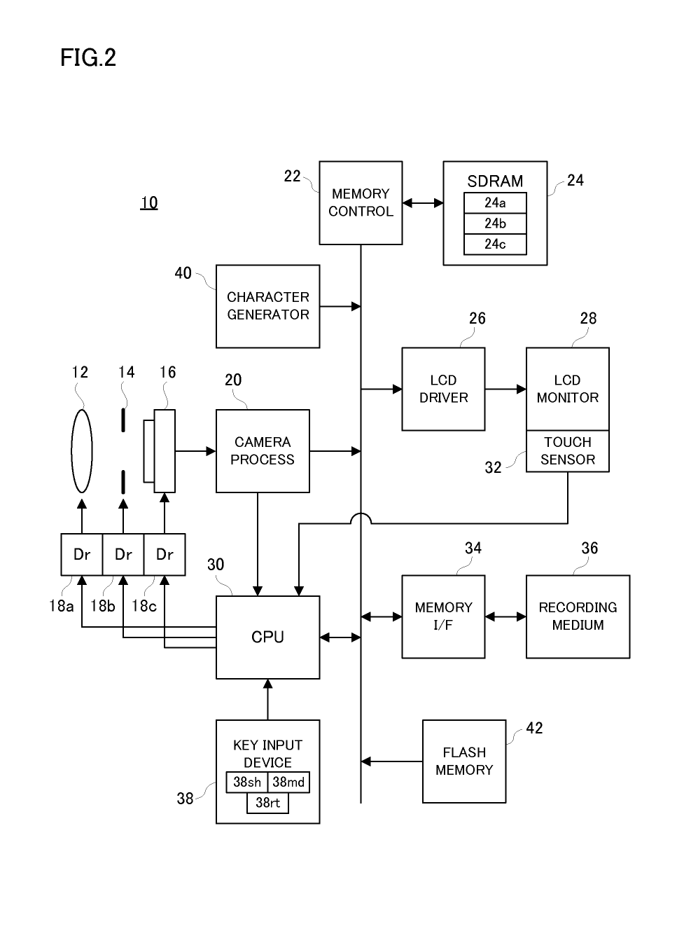

With reference to FIG. 2, a digital camera 10 according to one embodiment includes a focus lens 12 and an aperture unit 14 driven by drivers 18a and 18b, respectively. An optical image that underwent the focus lens 12 and the aperture unit 14 enters, with irradiation, an imaging surface of an imaging device 16, and is subjected to a photoelectric conversion. Thereby, electric charges representing a scene captured on the imaging surface are produced.

When a camera mode is selected by a mode selector switch 38md arranged in a key input device 38, in order to execute a moving-image taking process, a CPU 30 commands a driver 18c to repeat an exposure procedure and an electric-charge reading-out procedure, and commands an LCD driver 26 to display a moving image.

In response to a vertical synchronization signal Vsync outputted from an SG (Signal Generator) not shown, the driver 18c exposes the imaging surface and reads out the electric charges produced on the imaging surface in a raster scanning manner. From the imaging device 16, raw image data that is based on the read-out electric charges is cyclically outputted

A camera processing circuit 20 performs processes, such as white balance adjustment, color separation, and YUV conversion, on the raw image data outputted from the imaging device 16, and writes YUV formatted-image data created thereby, into a moving-image area 24a of an SDRAM 24 through a memory control circuit 22. The LCD driver 26 reads out the image data stored in the moving-image area 24a through the memory control circuit 22, and drives an LCD monitor 28 based on the read-out image data. As a result, a real-time moving image (a live view image) representing the scene captured on the imaging surface is displayed on a monitor screen.

When a shutter button 38sh arranged in the key input device 38 is in a non-operated state, the CPU 30 executes a simple AE process in order to calculate an appropriate EV value based on the image data created by the camera processing circuit 20. An aperture amount and an exposure time period that define the calculated appropriate EV value are set to the drivers 18b and 18c, respectively. As a result, a brightness of a live view image displayed on the LCD monitor 28 is adjusted approximately.

When the shutter button 38sh is half-depressed, in order to calculate an optimal EV value based on the image data created by the camera processing circuit 20, the CPU 30 executes a strict AE process. Similarly to described above, an aperture amount and an exposure time period that define the calculated optimal EV value are set to the drivers 18b and 18c, respectively. Thereby, the brightness of the live view image displayed on the LCD monitor 28 is adjusted strictly.

Subsequently, the CPU 30 executes an AF process with reference to a high-frequency component of the image data created by the camera processing circuit 20. The focus lens 12 is moved in an optical-axis direction, and is placed at a focal point thereafter. Thereby, a sharpness of the live view image displayed on the LCD monitor 28 is improved.

When the shutter button 38sh is full-depressed, the CPU 30 personally executes a still-image taking process and commands a memory I/F 34 to execute a recording process. Image data representing a scene at a time point when the shutter button 38sh is operated is evacuated from the moving-image area 24a to a still image area 24b as a photographed image data. The memory I/F 34 commanded to execute the recording process reads out the evacuated photographed image data through the memory control circuit 22, and records the read-out photographed image data on a recording medium 36 in a file format

When a reproducing mode is selected by the mode selector switch 38md, the CPU 30 executes following processes under a reproducing task

Firstly, in order to display an initial screen, the CPU 30 commands the memory I/F 34 to reproduce the latest image file, commands a character generator 40 to create menu icon data, and commands the LCD driver 26 to display a photographed image and a menu icon ICmn.

The memory I/F 34 reads out the photographed image data contained in the latest image file from the recording medium 36 so as to write the read-out photographed image data into the still-image area 24b of the SDRAM 24 through the memory control circuit 22. The character generator 40 creates the menu icon data so as to write the created menu icon data into a character image area 24c of the SDRAM 24 through the memory control circuit 22.

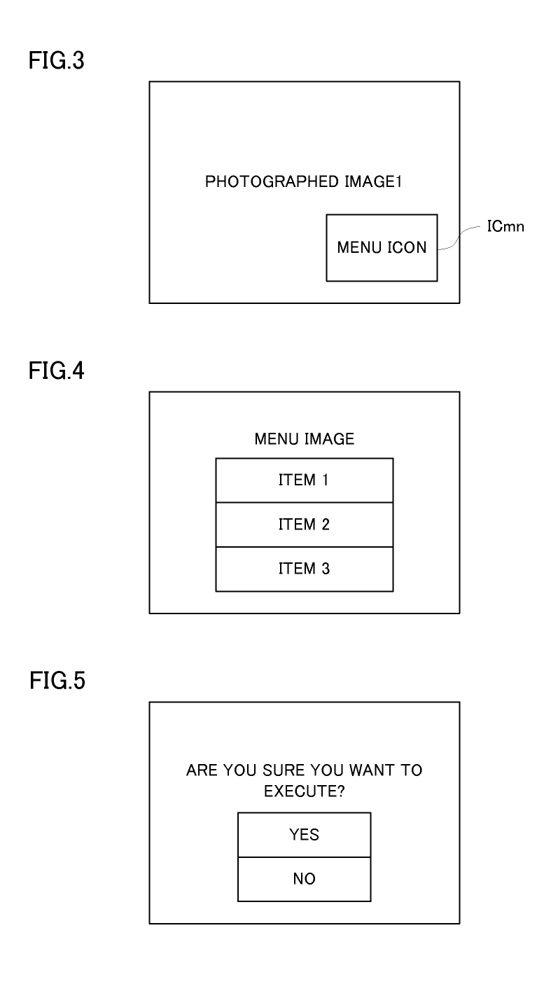

The LCD driver 26 reads out the photographed image data and menu icon data thus written into through the memory control circuit 22 so as to drive the LCD monitor 28 based on the read-out photographed image data and menu icon data. As a result, the photographed image and the menu icon ICmn are displayed on the monitor screen as shown in FIG. 3.

When the touch operation is performed to the monitor screen, it is detected by a touch sensor 32 which position on the monitor screen is touched and which of “flick” and “tap” is a manner of the touch operation. Detection information in which a touch position and an operation manner are described is outputted from the touch sensor 32.

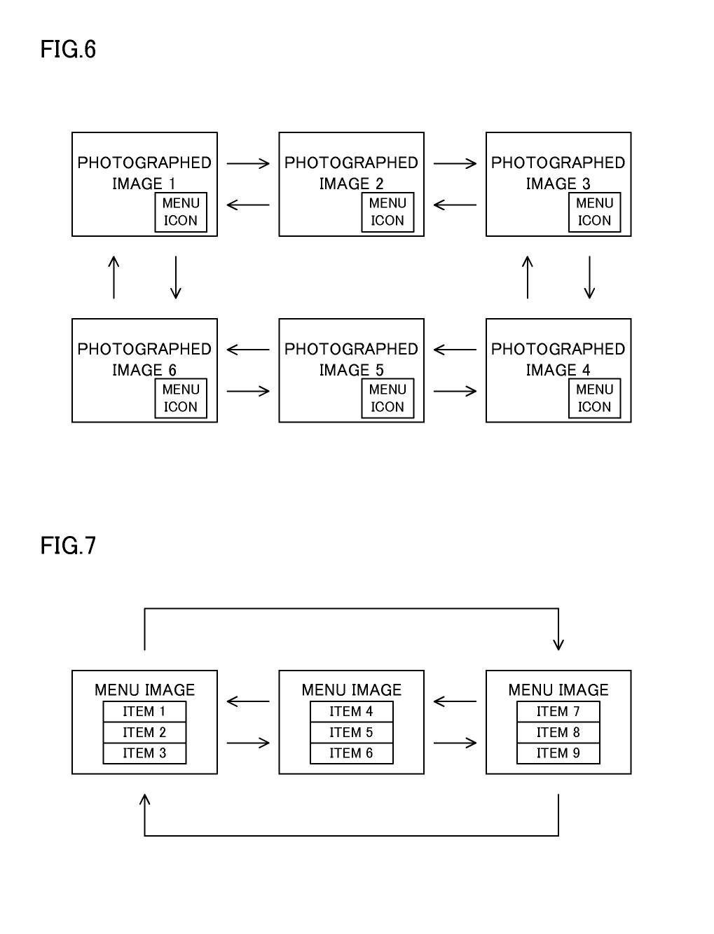

When detection information in which an operation manner indicating the “flick” is described is applied from the touch sensor 32 in a state where the photographed image and the menu icon ICmn are displayed on the LCD monitor 28, the CPU 30 commands the memory I/F 34 to reproduce a succeeding image file or a preceding image file. As a result, the photographed image displayed on the LCD monitor 28 is updated to another photographed image. Thus, the photographed image is updated as shown in FIG. 6 at every time a flick operation is performed.

When detection information in which an operation manner indicating the “tap” and the position of the menu icon ICmn are described is applied from the touch sensor 32 in a state where the photographed image and the menu icon ICmn are displayed, the CPU 30 respectively commands the character generator 40 and the LCD driver 26 to create menu image data and display a menu image.

The character generator 40 creates the menu image data so as to write the created menu image data into the character image area 24c through the memory control circuit 22. The LCD driver 26 reads out the menu image data from the character image area 24c through the memory control circuit 22 so as to drive the LCD monitor 28 based on the read-out menu image data. As a result, the display of the LCD monitor 28 is updated from the photographed image to the menu image shown in FIG. 4.

When the detection information in which the operation manner indicating the “flick” is described is applied from the touch sensor 32 in a state where the menu image is displayed on the LCD monitor 28, the CPU 30 commands the character generator 40 to create menu image data in which succeeding menu items or preceding menu items are listed. The character generator 40 creates the commanded menu image data so as to write the mated menu image data into the character image area 24c through the memory control circuit 22. As a result, the menu image displayed on the LCD monitor 28 is updated to another menu image. Thus, the menu image is updated as shown in FIG. 7 at every time the flick operation is performed

When detection information in which the operation manner indicating the “tap” and a position of any one of the menu items forming the menu image are described is applied from the touch sensor 32 in a state where the menu image is displayed, the CPU 30 commands the character generator 40 to create query image data and commands the LCD driver 26 to display a query image.

The character generator 40 mates the query image data so as to write the created query image data into the character image area 24c through the memory control circuit 22. The LCD driver 26 reads out the query image data from the character image area 24c through the memory control circuit 22 so as to drive the LCD monitor 28 based on the read-out query image data. As a result, the menu image is updated to the query image shown in FIG. 5.

When detection information in which the operation manner indicating the “tap” and a position of an item “YES” on the query image are described is applied from the touch sensor 32 in a state where the query image is displayed, the CPU 30 executes a process corresponding to the menu item tapped prior to displaying the query image. Thereby, changed are camera settings such as a transfer setting of the image file and a luminance setting of the LCD monitor 28.

Upon completion of changing the settings, the CPU 30 applies a corresponding command to the character generator 40 and the LCD driver 26 in order to display again the menu image displayed before the query image is displayed. The display of the LCD monitor 28 is updated from the query image to the menu image.

It is noted that, when detection information in which the operation manner indicating the “tap” and a position of an item “NO” on the query image are described is applied from the touch sensor 32, or when a return key 38rt arranged in a key input device 38 is operated, the display of the LCD monitor 28 is updated to the menu image without changing the settings.

Furthermore, when the return key 38rt is operated in a state where the menu image is displayed on the LCD monitor 28, the CPU 30 applies a corresponding command to the memory I/F 34 and the character generator 40 in order to display the photographed image and the menu icon ICmn displayed before the menu image is displayed. The display of the LCD monitor 28 is updated from the menu image to the photographed image and the menu icon ICmn.

Moreover, the CPU 30 increments a variable K when an image updated in response to the tap operation is the same as an image displayed before last time. However, the variable K is decremented in a range equal to or more than “0” when the image updated in response to the tap operation is different from the image displayed before last time. Moreover, the variable K is set to “0” when the detection information in which the operation manner indicating the “flick” is described is applied from the touch sensor 32.

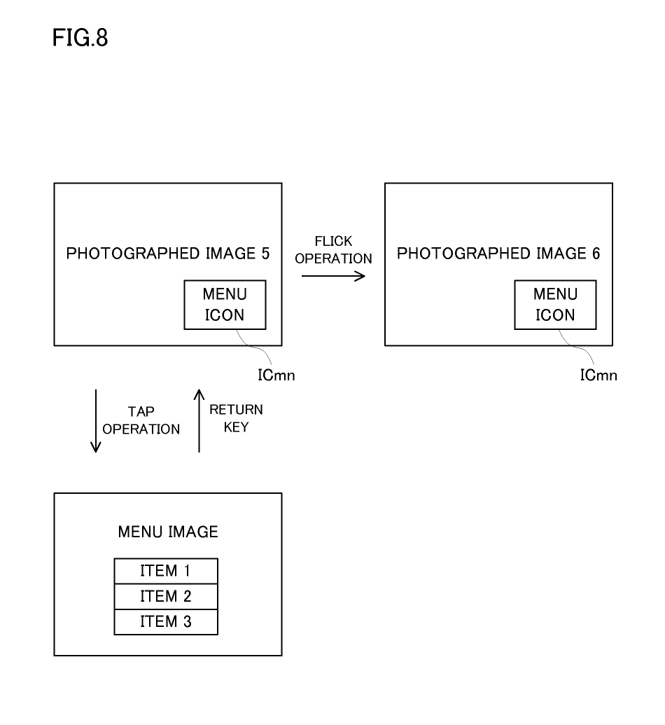

When an operation of tapping the menu icon ICmn displayed as shown in upper left of FIG. 8 and the operation of the return key 38rt are repeatedly detected, the display of the LCD monitor 28 is transitioned between an image shown in upper left of FIG. 8 and an image shown in lower left of FIG. 8. The variable K is incremented at every time the transition is repeated. On the other hand, when a flick operation to the image shown in upper left of FIG. 8 is detected, the display of the LCD monitor 28 is transitioned to an image shown in upper right of FIG. 8, and the variable K is set to “0”.

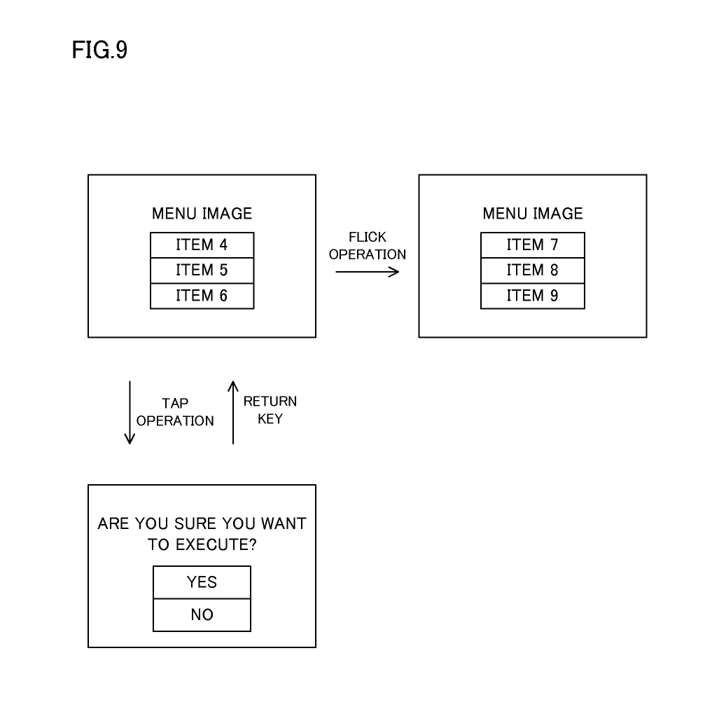

Moreover, when an operation of tapping any one of the menu items displayed as shown in upper left of FIG. 9 and the operation of the return key 38rt are repeatedly detected, the display of the LCD monitor 28 is transitioned between an image shown in upper left of FIG. 9 and an image shown in lower left of FIG. 9. The variable K is incremented at every time the transition is repeated On the other hand, when a flick operation to the image shown in upper left of FIG. 9 is detected, the display of the LCD monitor 28 is transitioned to an image shown in upper right of FIG. 9, and the variable K is set to “0”.

When a value of the variable K thus updated exceeds a threshold value TH1 (=3), the CPU 30 respectively commands the character generator 40 and the LCD driver 26 to create small size of alternate icon data and to display an alternate icon ICsb.

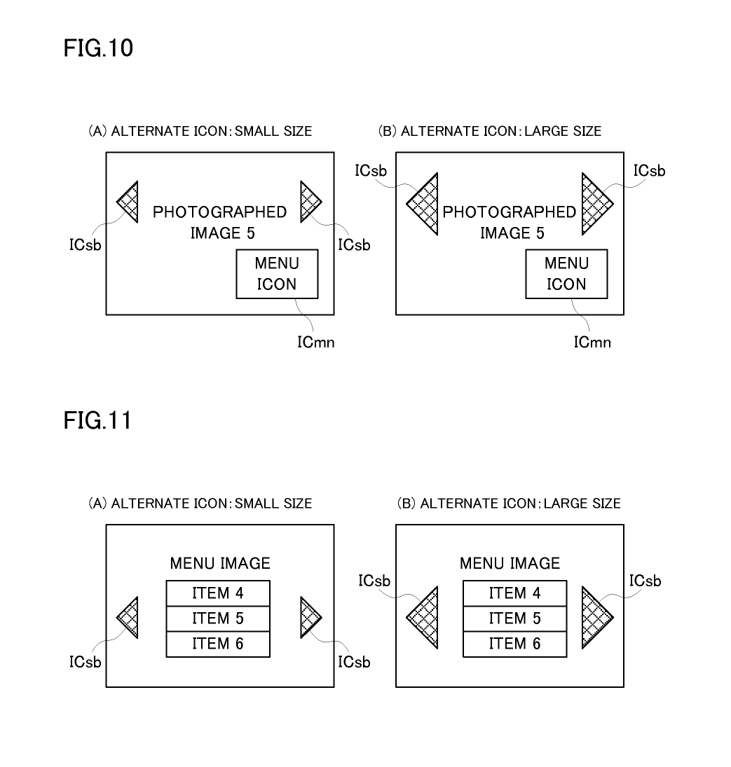

The character generator 40 creates the small size of the alternate icon data so as to write the created alternate icon data into the character image area 24c of the SDRAM 24 through the memory control circuit 22. The LCD driver 26 reads out the alternate icon data from the character image area 24c through the memory control circuit 22 so as to drive the LCD monitor 28 based on the read-out alternate icon data. As a result, a small size of the alternate icon ICsb is displayed in an overlapped manner on the LCD monitor 28 as shown in FIG. 10(A) or FIG. 11(A).

Moreover, when the value of the variable K exceeds a threshold value TH2 (=5), the CPU 30 commands the character generator 40 to create large size of alternate icon data. The character generator 40 creates the large size of alternate icon data so as to write the created alternate icon data into the character image area 24c of the SDRAM 24 through the memory control circuit 22. The small size of alternate icon data existing in the character image area 24c is updated by the large size of the alternate icon data, and the LCD driver 28 reads out the updated alternate icon data. As a result, the large size of the alternate icon ICsb is displayed in the overlapped manner on the LCD monitor 28 as shown in FIG. 10(B) or FIG. 11(B).

Furthermore, when the variable K is set to “0”, the CPU 30 commands the LCD driver 26 to suspend displaying the alternate icon ICsb. The LCD driver 26 suspends reading out the alternate icon data stored in the character image area 24c. As a result, the alternate icon ICsb disappears from the monitor screen. It is noted that actual values of the small size and the large size are defined by using an age of a user preliminary set as a reference. That is, these size values are increased as the age of the user increases.

When detection information in which the operation manner indicating the “tap” and a position of the alternate icon ICsb are described is applied from the touch sensor 32 in a state when the photographed image and the menu icon ICmn are displayed, the CPU 30 commands the memory I/F 34 to reproduce a succeeding image file or a preceding image file. As a result, the photographed image displayed on the LCD monitor 28 is updated to another photographed image.

Furthermore, when detection information in which the operation manner indicating the “tap” and the position of the alternate icon ICsb are described is applied from the touch sensor 32 in a state when the menu image is displayed, the CPU 30 commands the character generator 40 to create menu image data in which succeeding menu items or preceding menu items are listed. As a result, the menu image displayed on the LCD monitor 28 is updated to another menu image.

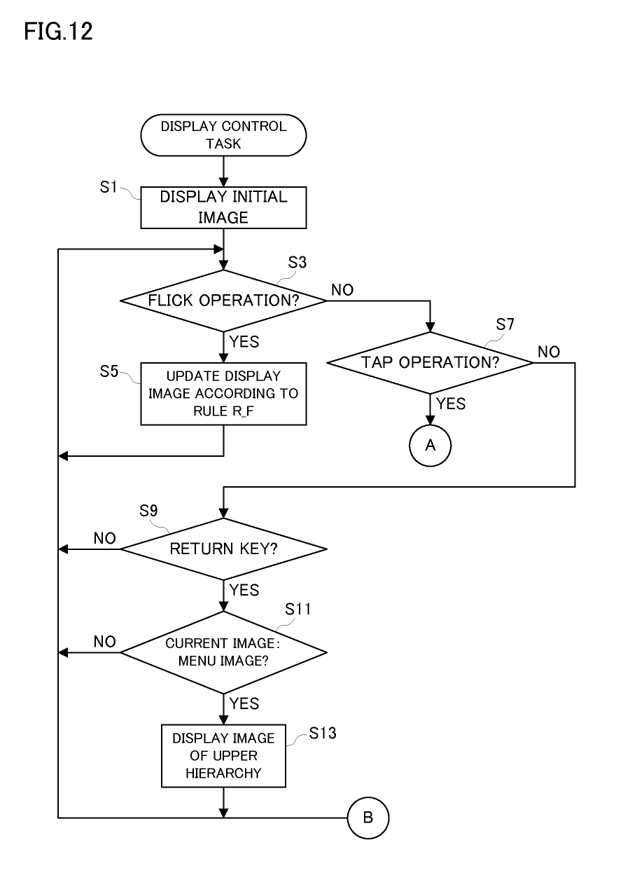

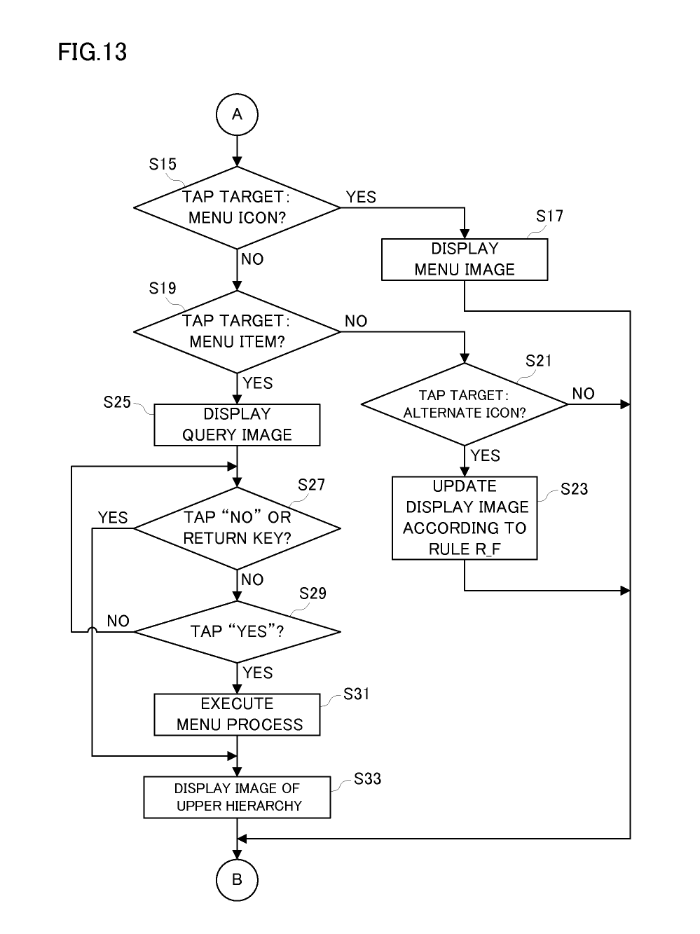

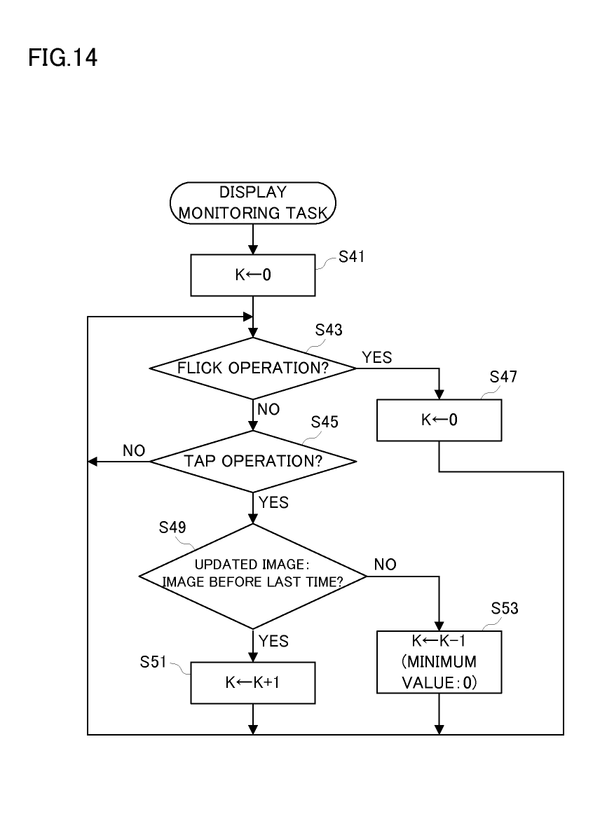

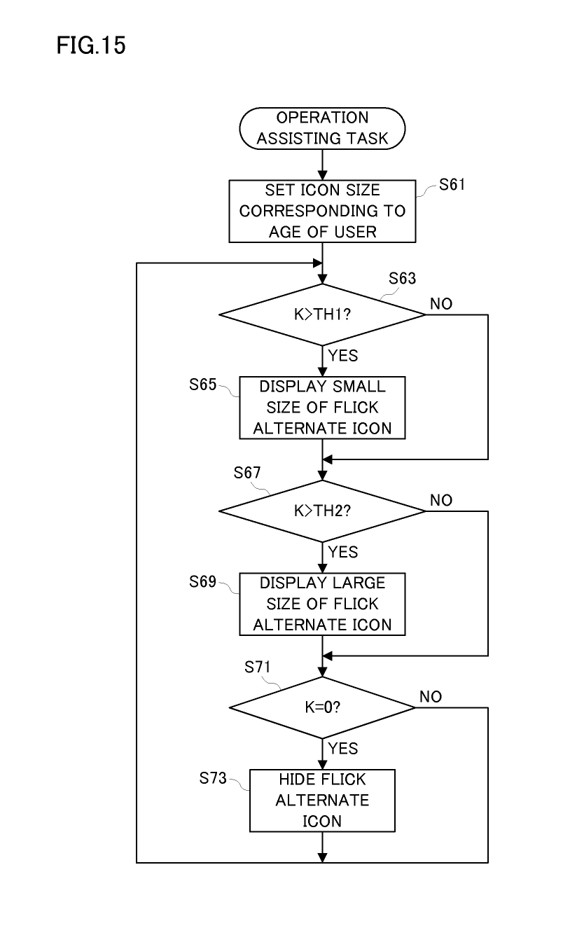

When the reproducing mode is selected, the CPU 30 executes, under a control of the multi task operating system, a plurality of tasks including a display control task shown in FIG. 12 to FIG. 13, a display monitoring task shown in FIG. 14 and an operation assisting task shown in FIG. 15, in a parallel manner. It is noted that control programs corresponding to these tasks are stored in a flash memory 42.

With reference to FIG. 12, in a step S1, in order to display an initial screen, the memory I/F 34 is commanded to reproduce the latest image file, the character generator 40 is commanded to create menu icon data, and the LCD driver 26 is commanded to display a photographed image and the menu icon ICmn.

The memory I/F 34 reads out the photographed image data contained in the latest image file from the recording medium 36 so as to write the read-out photographed image data into the still-image area 24b of the SDRAM 24 through the memory control circuit 22. The character generator 40 creates the menu icon data so as to write the created menu icon data into the character image area 24c of the SDRAM 24 through the memory control circuit 22.

The LCD driver 26 reads out the photographed image data and menu icon data thus written from the SDRAM 24 through the memory control circuit 22 so as to drive the LCD monitor 28 based on the read-out photographed image data and menu icon data. As a result, the photographed image and the menu icon ICmn are displayed on the monitor screen.

In a step S3, it is determined whether or not the flick operation is performed to the monitor screen, based on a description of detection information applied from the touch sensor 32, and in a step S7, it is determined whether or not the tap operation is performed, based on the description of the detection information applied from the touch sensor 32. In a step S9, it is determined whether or not the return key 38rt is operated, based on output of the key input device 38.

When a determined result of the step S3 is YES, the process advances to a step S5 so as to update the display of the LCD monitor 28 according to a rule R_F. When a display image at a current time point is the photographed image, the process in the step S5 is equivalent to a process of commanding the memory I/F 34 to reproduce a succeeding image file or a preceding image file. Moreover, when a display image at a current time point is the menu image, a process in the step S5 is equivalent to a process of commanding the character generator 40 to create menu image data in which succeeding menu items or preceding menu items are listed. As a result, the photographed image or the menu image displayed on the LCD monitor 28 is updated to another photographed image or menu image. Upon completion of the process in the step S5, the process returns to the step S3.

When a determined result of the step S9 is YES, in a step S11, it is determined whether or not an image displayed on the LCD monitor 28 at a current time point is the menu image. When a determined result is NO, the process directly returns to the step S3 whereas when the determined result is YES, the process returns to the step S3 via a process in a step S13.

In the step S13, in order to display the photographed image and the menu icon ICmn displayed before the menu image is displayed, a corresponding command is applied to the memory I/F 34 and the character generator 40. The display of the LCD monitor 28 is updated from the menu image to the photographed image and the menu icon ICmn.

When a determined result of the step S7 is YES, in a step S15, it is determined whether or not a tap target is the menu icon ICmn overlapped on the photographed image, and in a step S19, it is determined whether or not the tap target is any one of a plurality of menu items listed on the menu image. In a step S21, it is determined whether or not the tap target is the alternate icon ICsb displayed in a step S69 or S73 described later. These determining processes are executed based on an attribute of an image displayed at a current time point and the description of the detection information applied from the touch sensor 32.

When a determined result of the step S15 is YES, the process advances to a step S17 so as to command the character generator 40 and the LCD driver 26 to reproduce menu image data and to display the menu image. The character generator 40 creates the menu image data so as to write the created menu image data into the character image area 24c through the memory control circuit 22. The LCD driver 26 reads out the menu image data from the character image area 24c through the memory control circuit 22 so as to drive the LCD monitor 28 based on the read-out menu image data. As a result, the display of the LCD monitor 28 is updated from the photographed image to the menu image. Upon completion of the process in the step S17, the process returns to the step S3.

When a determined result of the step S21 is YES, a process similar to the step S5 is executed in a step S23. As a result, the photographed image or the menu image displayed on the LCD monitor 28 is updated to another photographed image or menu image. Upon completion of the process in the step S23, the process returns to the step S3.

When a determined result of the step S19 is YES, the character generator 40 is commanded to create query image data, and the LCD driver 26 is commanded to display a query image. The character generator 40 creates the query image data so as to write the created query image data into the character image area 24c through the memory control circuit 22. The LCD driver 26 reads out the query image data from the character image area 24c through the memory control circuit 22 so as to drive the LCD monitor 28 based on the read-out query image data. As a result, the menu image is updated to the query image.

In a step S27, it is determined whether or not an OR condition under which the item “NO” on the displayed query image is tapped or the return key 38rt is operated, based on outputs of the touch sensor 32 and the key input device 38. Moreover, in a step S29, it is determined whether or not the item “YES” on the query image is tapped, based on output of the touch sensor 32.

When a determined result of the step S27 is YES, the process directly advances to a step S33. On the other hand, when a determined result of the step S29 is YES, a process corresponding to the tapped menu item is executed in a step S31, and thereafter, the process advances to the step S33. In the step S33, a corresponding command is applied to the character generator 40 and the LCD driver 26 in order to display again the menu image displayed before the query image is displayed. The display of the LCD monitor 28 is updated from the query image to the menu image. Upon completion of the process in the step S33, the process returns to the step S3.

With reference to FIG. 14, in a step S41, the variable K is set to “0”. In a step S43, it is determined whether or not the flick operation is performed, based on the description of the detection information applied from the touch sensor 32, and in a step S45, it is determined whether or not the tap operation is performed, based on the description of the detection information applied from the touch sensor 32. When a determined result of the step S43 is YES, the variable K is set to “0” in a step S47, and thereafter, the process returns to the step S43.

When a determined result of the step S45 is YES, in a step S49, it is determined whether or not an image updated in response to the tap operation is equivalent to a display image before last time. When a determined result is YES, the process advances to a step S51 so as to increment the variable K In contrary, when the determined result is NO, the process advances to a step S53 so as to decrement the variable K in a range equal to or more than “0”. Upon completion of the process in the step S51 or S53, the process returns to the step S43.

With reference to FIG. 15, an icon size corresponding to the age of the user is set in a step S61. In a step S63, it is determined whether or not the variable K exceeds the threshold value TH1 (=3), and in a step S67, it is determined whether or not the variable K exceeds the threshold value TH2 (=5). In a step S71, it is determined whether or not the variable K is “0”.

When a determined result of the step S63 is YES, the process advances to a step S65 so as to command the character generator 40 and the LCD driver 26 to create small size of alternate icon data and to display the alternate icon ICsb.

The character generator 40 creates the small size of the alternate icon data so as to write the created alternate icon data into the character image area 24c of the SDRAM 24 through the memory control circuit 22. The LCD driver 26 reads out the alternate icon data from the character image area 24c through the memory control circuit 22 so as to drive the LCD monitor 28 based on the read-out alternate icon data. As a result, a small size of the alternate icon ICsb is displayed in an overlapped manner on the LCD monitor 28.

When a determined result of the step S67 is YES, the process advances to the step S69 so as to command the character generator 40 to create large size of alternate icon data. The character generator 40 creates the large size of the alternate icon data so as to write the created alternate icon data into the character image area 24c of the SDRAM 24 through the memory control circuit 22. The small size of the alternate icon data existing in the character image area 24c is updated by the large size of the alternate icon data. The LCD driver 28 reads out the updated alternate icon data. As a result, the large size of the alternate icon ICsb is displayed in the overlapped manner on the LCD monitor 28.

When a determined result of the step S71 is YES, in the step S73, the LCD driver 26 is commanded to suspend displaying the alternate icon ICsb. The LCD driver 26 suspends reading out the alternate icon data stored in the character image area 24c. As a result, the alternate icon ICsb disappears from the monitor screen.

It is noted that actual values of the small size and the large size are defined by using the icon size set in the step S61 as reference. Moreover, regarding the step S65, S69 or S73, the twice consecutive process does not make sense.

As can be seen [tom the above-described explanation, the CPU 30 updates the display of the LCD monitor 28 according to the rule R_F when the flick operation to the LCD monitor 28 is detected (S3 to S5), and updates the display of the LCD monitor 28 according to another rule when the tap operation to the LCD monitor 28 is detected (S7, S15 to S19, S25). Moreover, the CPU 30 displays the alternate icon ICsb on the LCD monitor 28 when the updating manner of the display of the LCD monitor 28 satisfies the error condition (S45, S49 to S51, S63 to S69), and updates the display of the LCD monitor 28 according to the rule R_F when the tap operation to the displayed alternate icon ICsb is detected (S7, S21 to S23).

When the flick operation is erroneously detected as the tap operation, the display of the LCD monitor 28 is updated according to a rule different from the rule R_F When the error condition is satisfied as a result of frequency of the update, the alternate icon ICsb is displayed on the LCD monitor 28. Updating the display according to the rule R_F is executed in response to the tap operation to the alternate icon ICsb. Therefore, an operability is improved.

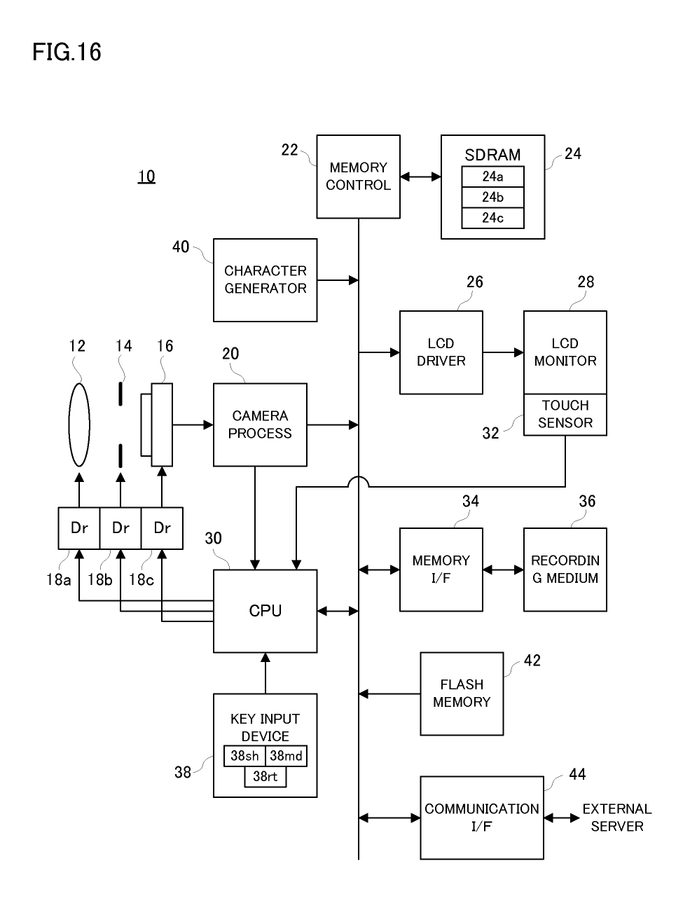

Moreover, in this embodiment, the control programs equivalent to the multi task operating system and a plurality of tasks executed thereby are previously stored in the flash memory 42. However, a communication I/F 44 may be arranged in the digital camera 10 as shown in FIG. 16 so as to initially prepare a part of the control programs in the flash memory 42 as an internal control program whereas acquire another part of the control programs from an external server as an external control program. In this case, the above-described procedures are realized in cooperation with the internal control program and the external control program.

Furthermore, in this embodiment, the processes executed by the main CPU 30 are divided into a plurality of tasks in a manner described above. However, these tasks may be further divided into a plurality of small tasks, and furthermore, a part of the divided plurality of small tasks may be integrated into another task. Moreover, when each of tasks is divided into the plurality of small tasks, the whole task or a part of the task may be acquired from the external server.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A user interface apparatus, comprising:
a first updater which updates a display of a monitor screen according to a first rule when a touch operation of a first manner to said monitor screen is detected;
a second updater which updates the display of said monitor screen according to a second rule when a touch operation of a second manner to said monitor screen is detected;
a displayer which displays a specific icon on said monitor screen when an updating manner of the display of said monitor screen satisfies an error condition; and
a specific updater which updates the display of said monitor screen according to the first rule when a touch operation to the specific icon displayed by said displayer is detected.

2. A user interface apparatus according to claim 1, wherein the error condition includes a condition under which a number of times that a common image is periodically displayed exceeds a reference.

3. A user interface apparatus according to claim 1, wherein the touch operation of the first manner is equivalent to a flick operation, and the touch operation of the second manner is equivalent to a tap operation.

4. A user interface apparatus according to claim 1, wherein the touch operation noticed by said specific updater is equivalent to the touch operation of the second manner.

5. A user interface apparatus according to claim 1, further comprising a third updater which updates the display of said monitor screen according to a third rule when an operation to an operation unit is detected.

6. A display control program recorded on a non-transitory recording medium in order to control a user interface apparatus provided with a monitor screen, the program causing a processor of the user interface apparatus to perform the steps comprising:
a first updating step of updating a display of a monitor screen according to a first rule when a touch operation of a first manner to said monitor screen is detected;
a second updating step of updating the display of said monitor screen according to a second rule when a touch operation of a second manner to said monitor screen is detected;
a displaying step of displaying a specific icon on said monitor screen when an updating manner of the display of said monitor screen satisfies an error condition; and
a specific updating step of updates the display of said monitor screen according to the first rule when a touch operation to the specific icon displayed by said displaying step is detected.

7. A display control method executed by a user interface apparatus provided with a monitor screen, comprising:
a first updating step of updating a display of a monitor screen according to a first rule when a touch operation of a first manner to said monitor screen is detected;
a second updating step of updating the display of said monitor screen according to a second rule when a touch operation of a second manner to said monitor screen is detected;
a displaying step of displaying a specific icon on said monitor screen when an updating manner of the display of said monitor screen satisfies an error condition; and
a specific updating step of updates the display of said monitor screen according to the first rule when a touch operation to the specific icon displayed by said displaying step is detected.
